(19) United States
(12) Patent Application Publication
(10) Pub. No.: US 2026/0099259 A1
(43) Pub. Date: Apr. 9, 2026

(54) MEMORY SYSTEMS, CONTROLLERS, OPERATING METHODS, STORAGE MEDIUMS, AND PROGRAM PRODUCTS

(71) Applicant: YANGTZE MEMORY TECHNOLOGIES CO., LTD., Wuhan (CN)

(72) Inventor: Haochiang HSU, Wuhan (CN)

(21) Appl. No.: 19/052,079

(22) Filed: Feb. 12, 2025

(30) Foreign Application Priority Data
Oct. 9, 2024 (CN) 202411406276X

(51) Int. Cl. G06F 3/06

(52) U.S. Cl. CPC G06F 3/0622; G06F 3/0659; G06F 3/0679

(57) ABSTRACT

Examples of the present disclosure provide memory systems, memory controllers, operating methods, computer readable storage mediums, and computer program products. An example method includes: determining being at a read scenario with a queue depth of 1; receiving a read operation instruction from a host; determining a first read command based on the read operation instruction; sending the first read command to the first die; and sending a second read command to a second die different from the first die in parallel. The first read command comprises a first physical address, and the first physical address corresponds to a first die. The second read command is for patrolling.

### CROSS-REFERENCE TO RELATED APPLICATIONS

The present application claims priority to Chinese Patent Application No. 202411406276X, which was filed Oct. 9, 2024, and is hereby incorporated herein by reference in its entirety.

### TECHNICAL FIELD

The present disclosure relates to the technical field of semiconductors, and in particular, to a memory system, a memory controller, an operating method, a computer-readable storage medium, and a computer program product.

### BACKGROUND

In a memory system, such as a Solid-State Drive (SSD), patrolling usually refers to performing periodic check and maintenance on the memory system, for example, inspecting a memory device in the memory system with a fixed time or a fixed command to ensure normal operation and data security of the memory device. The patrolling operation may be performed in the background after the memory system is powered on.

### SUMMARY

The examples of the present disclosure provide a memory system, a memory controller, an operating method, a computer readable storage medium and a computer program product.

According to one aspect of an example of the present disclosure, there is provided a memory system, comprising: a plurality of dies; and a memory controller coupled to the plurality of dies; wherein the memory controller is configured to: determine being at a read scenario with a queue depth of 1 (QD1); receive a read operation instruction from a host; determine a first read command based on the read operation instruction, wherein the first read command includes a first physical address, and the first physical address corresponds to a first die; send the first read command to the first die, and send a second read command to a second die different from the first die in parallel, wherein the second read command is for patrolling.

In an example, the memory controller is configured to: determine being at the read scenario with the queue depth of 1, when a depth of a submission queue of the host is 1, the submission queue includes the read operation instruction, and a quantity of consecutively received read operation instructions exceeds a defined quantity threshold.

In an example, the second read command is a page read command or a multi-plane read command.

In an example, the memory controller is further configured to prohibit sending the second read command for patrolling, when an operation instruction different from the read operation instruction is received from the host or a plurality of read operation instructions are received.

In an example, the memory controller is configured to send the first read command to the first die and send the second read command to all other dies different from the first die in parallel.

In an example, the memory controller is configured to send the first read command to the first die and send the second read command to one or more dies different from the first die in parallel.

In an example, the memory controller is further configured to: obtain the read operation instruction from a submission queue (SQ) of the host; receive a completion result of a first read command from a memory device; and write the completion result of the first read command to a completion queue (CQ) of the host.

In an example, the memory controller is further configured to receive a completion result of the second read command from the second die.

In an example, the second read command indicates to perform a sequential read on memory cells of the second die.

According to another aspect of examples of the present disclosure, there is provided a memory controller, comprising: a controller memory configured to store control instructions; and a controller processor coupled to the controller memory and configured to execute the control instructions to perform processing, the processing comprising: determining being at a read scenario with a queue depth of 1; receiving a read operation instruction from a host; determining a first read command based on the read operation instruction, wherein the first read command includes a first physical address, and the first physical address corresponds to a first die; sending the first read command to the first die, and sending a second read command to a second die different from the first die in parallel, wherein the second read command is for patrolling.

In an example, the processing includes: determining being at the read scenario with the queue depth of 1, when a length of a submission queue of the host is 1, the submission queue includes the read operation instruction, and a quantity of consecutively received read operation instructions exceeds a defined quantity threshold.

In an example, the second read command is a page read command or a multi-plane read command.

In an example, the processing further includes: prohibiting sending the second read command for patrolling, when an operation instruction different from the read operation instruction is received from the host, or a plurality of read operation instructions are received.

In an example, the processing includes sending the first read command to the first die and sending the second read command to all other dies different from the first die in parallel.

In an example, the processing includes sending the first read command to the first die and sending the second read command to one or more dies different from the first die in parallel.

In an example, the processing further includes: reading the read operation instruction from a submission queue of the host; receiving a completion result of a first read command from a memory device; and writing the completion result of the first read command to a completion queue of the host.

In an example, the process further includes receiving a completion result of the second read command from a memory device.

In an example, the second read command indicates to perform a sequential read on memory cells of the second die.

According to yet another aspect of examples of the present disclosure, there is provided a method of operating a memory controller, comprising: determining being at a read scenario with a queue depth of 1; receiving a read operation instruction from a host; determining a first read command based on the read operation instruction, wherein the first read command includes a first physical address, and the first physical address corresponds to a first die; sending the first read command to the first die, and sending a second read command to a second die different from the first die, wherein the second read command is for patrolling.

In an example, determining that a memory system is at a read scenario with a queue depth of 1 includes: determining being at the read scenario with the queue depth of 1, when a length of a submission queue of the host is 1, the submission queue includes the read operation instruction, and a quantity of consecutively received read operation instructions exceeds a defined quantity threshold.

In an example, the second read command is a page read command or a multi-plane read command.

In an example, the method further includes: prohibiting sending the second read command for patrolling, when an operation instruction different from the read operation instruction is received from the host, or a plurality of read operation instructions are received.

In an example, the sending a second read command to a second die different from the first die includes sending the second read command to all other dies different from the first die.

In an example, the sending a second read command to a second die different from the first die includes sending the second read command to one or more dies different from the first die.

In an example, the method further comprises: reading the read operation instruction from a submission queue (SQ) of the host; receiving a completion result of a first read command from a memory device; writing the completion result of the first read command to a completion queue (CQ) of the host.

In an example, the method further includes receiving a completion result of the second read command from a memory device.

In an example, the second read command indicates to perform a sequential read on memory cells of the second die.

According to still another aspect of the examples of the present disclosure, a computer-readable storage medium is provided, wherein when control instructions in the computer-readable storage medium are executed by a controller processor, causing the controller processor to perform the operating method as described above.

According to still another aspect of the examples of the present disclosure, a computer program product is provided, including computer programs/instructions, which when executed by a processor, implement the operating method as described above.

The above general description and the following detailed description are exemplary and explanatory only and are not intended to limit the present disclosure.

### BRIEF DESCRIPTION OF THE DRAWINGS

The drawings herein, which are incorporated in and constitute a part of the description, illustrate examples consistent with the present disclosure and, together with the description, serve to explain the principles of the present disclosure. Obviously, the drawings in the following descriptions are only some examples of the present disclosure, and for those of ordinary skill in the art, other drawings may be obtained according to these drawings without inventive effort.

FIG. 1 illustrates a block diagram of an example system having a memory system according to an example of the present disclosure.

FIG. 2A illustrates a block diagram of a memory system according to an example of the present disclosure.

FIG. 2B illustrates a block diagram of another memory system according to an example of the present disclosure.

FIG. 2C illustrates a block diagram of yet another memory system according to an example of the present disclosure.

FIG. 3 illustrates a schematic circuit diagram of a memory device including a peripheral circuit provided according to an example of the present disclosure.

FIG. 4 illustrates a schematic diagram of a peripheral circuit provided according to an example of the present disclosure.

FIG. 5 illustrates a schematic diagram of an architecture of a memory system according to an example of the present disclosure.

FIG. 6A illustrates a flowchart of a memory system operating method according to an example of the present disclosure.

FIG. 6B illustrates a schematic diagram of a column address according to an example of the present disclosure.

FIG. 7 illustrates a flowchart of a memory system operating method according to another example of the present disclosure.

FIGS. 8A-8E illustrate schematic diagrams of a host and a memory controller completing processing of a read operation instruction based on a submission queue and a completion queue according to an example of the present disclosure.

FIG. 9 illustrates a flowchart of a memory system operating method according to still another example of the present disclosure.

FIG. 10 illustrates a schematic diagram of a memory system according to an example of the present disclosure.

FIG. 11 illustrates a schematic diagram of a conflict between a read command from host and a read command for patrolling.

FIG. 12 illustrates a sequence diagram of a page read command according to an example of the present disclosure.

FIG. 13 illustrates a sequence diagram of a multiplane read command according to an example of the present disclosure.

FIG. 14A illustrates a schematic diagram of high delay resulting from a patrolling read on a host read.

FIG. 14B illustrates a schematic diagram of not resulting high delay after avoiding a patrolling conflict according to the present disclosure.

### DETAILED DESCRIPTION

Examples will now be described more fully with reference to the accompanying drawings. However, the examples can be embodied in a variety of forms and should not be construed as limited to the examples set forth herein; rather, these examples are provided so that the present disclosure will be thorough and complete and will fully conveys the concepts of the examples to those skilled in the art. Like reference numerals refer to like or similar parts in the drawings, and thus repeated description thereof will be omitted.

The features, structures, or characteristics described in the present disclosure may be incorporated in one or more examples in any suitable manner. In the following descriptions, numerous specific details are provided to give a thorough understanding of examples of the present disclosure. Those skilled in the art will appreciate, however, that the technical solutions of the present disclosure may be practiced with one or more of the specific details omitted, or other methods, components, devices, steps, etc. may be employed. In other instances, well-known methods, apparatus, implementations, or operations are not shown or described in detail to avoid obscuring aspects of the present disclosure.

The drawings are merely schematic illustrations of the present disclosure, and like reference numerals refer to like or similar parts in the drawings, and thus repeated description thereof will be omitted. Some of the block diagrams shown in the drawings do not necessarily have to correspond to physically or logically separate entities. These functional entities may be implemented in software form, or implemented in at least one hardware module or integrated circuit, or implemented in different networks and/or processor devices and/or microcontroller devices.

The flowchart shown in the drawings is merely an example illustration, which does not necessarily include all of the content and steps, nor must be performed in the order described. For example, the steps may be further decomposed, and some steps may be combined or partially combined, so the actual execution sequence may be changed according to actual conditions.

In the description, the terms “a”, “an”, “the”, “said”, and “at least one” are used to indicate that there are at least one element/component/etc. ; the terms “including”, “comprising”, and “having” are used to indicate an open-ended inclusion and refer to that there may be additional elements/components/etc. in addition to the listed elements/components/etc. ; the terms “first”, “second”, and “third” are used merely as labels, and not as limits to the quantity of objects thereof.

Terms referred to herein are described below.

A read scenario with a Queue Depth (QD) of 1, QD1 read, is used to evaluate the read performance when the queue depth is 1. The queue depth refers to a quantity of I/O requests that can be processed by a device within a same time. QD1 refers to that only one request in the queue is waiting to be processed. QD1 read is typically used to evaluate the performance of SSDs in light load situations, which simulates the performance of a single user or a simple application accessing to a memory device. In benchmarking, a tester measures the number of I/O operations per second (IOPS) and read delay under QD1 conditions to learn about the responsiveness of the SSD in low load situations. QD1 read QoS is an evaluation index, which reflects the ability of the SSD to process a read command. The latencies of all IOs are sorted in ascending order when testing, and a value of 99.99% is taken to determine the latency performance of the SSD.

The present disclosure finds that patrolling is performed in a QD1 read scenario, and when a patrolling read command is executed, a conflict with a host read command is caused, so that the read latency is increased, and the index value becomes worse. The present disclosure provides such an inventive concept: by detecting the QD1 read scenario, starting the patrolling mode to avoid a die where the host read command occurs, and completing the patrolling read command and the host read command at the same time, such that the conflict caused by the host read command and the patrolling read command is avoided, and the latency of QoS 99.99% is reduced.

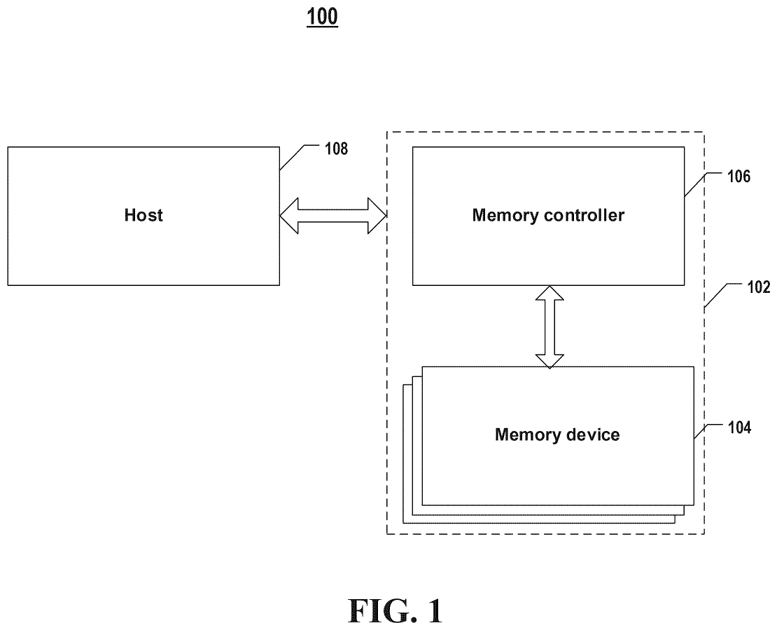

FIG. 1 shows a schematic diagram of an example system with a memory device according to an example of the present disclosure. As shown in FIG. 1, the system 100 may be a mobile phone, a desktop computer, a portable computer, a tablet computer, a vehicle computer, a game console, a printer, a positioning device, a wearable electronic device, a smart sensor, a virtual reality (VR) device, an augmented reality (AR) device, or any other suitable electronic device having a memory device therein. As shown in FIG. 1, the system 100 may include a host 108 and a memory system 102 having one or more memory devices 104 and a memory controller 106.

The host 108 may be a processor (for example, a central processing unit (CPU)) or a system on chip (SoC) (for example, an application processor (AP)) of the system 100. The host 108 may be coupled to the memory controller 106 and configured to send data to or receive data from the memory device 104 through the memory controller 106. For example, the host 108 may send program data in a program operation or receive read data in a read operation. The host 108 is configured to receive instructions and commands from the memory controller 106 of the memory system 102 and to send instructions and commands to the memory controller 106 of the memory system 102, and to perform or implement the various functions and operations provided in the present disclosure, as will be described below.

The memory device 104 may be any memory disclosed in the present disclosure, such as a NAND flash memory that includes a page buffer having multiple portions. Note that NAND flash memory is only one example of memory for illustrative purposes. The memory device 104 may include any suitable non-volatile memory, such as NOR flash memory, ferroelectric random-access memory (FeRAM), phase change memory (PCM), magnetoresistive random access memory (MRAM), spin-transfer torque random access memory (STT-RAM), resistive random-access memory (RRAM), or the like. In some implementations, the memory device 104 includes a three-dimensional (3D) NAND flash memory.

The memory controller 106 may be implemented by microprocessor, microcontroller (also referred to as a microcontroller unit (MCU)), digital signal processor (DSP), application specific integrated circuit (ASIC), field-programmable gate array (FPGA), programmable logic device (PLD), state machine, gating logic, discrete hardware circuit, and other suitable hardware, firmware, and/or software configured to perform various functions described in detail below.

According to some implementations, the memory controller 106 is coupled to the memory device 104 and the host 108, and is configured to control the memory device 104. The memory controller 106 may manage data stored in the memory device 104 and communicate with the host 108. In some implementations, the memory controller 106 is designed to operate, in a low duty cycle environment, such as a Secure Digital (SD) card, a Compact Flash (CF) card, a Universal Serial Bus (USB) flash drive, or other medium for use in electronic devices (e.g., personal computers, digital cameras, mobile phones, etc.). In some implementations, the memory controller 106 is designed for to operate, in a high duty cycle environment, SSDs or embedded MultiMedia Cards (eMMCs) used as data storage devices for mobile devices (e.g., smartphones, tablets, laptops, etc.) and enterprise storage arrays. The memory controller 106 may be configured to control the operations, e.g., read, erase, and program operations, of the memory device 104 by providing instructions, such as read instructions, to the memory device 104. For example, the memory controller 106 may be configured to provide read instructions to peripheral circuit of the memory device 104 to control read operations. The memory controller 106 may also be configured to manage various functions regarding data stored or to be stored in the memory device 104, including, but not limited to, bad block management, garbage collection (GC), logical-to-physical address translation, wear leveling, and the like. In some implementations, the memory controller 106 is further configured to process Error Correcting Code (ECC) regarding data read from or written to the memory device 104. The memory controller 106 may also perform any other suitable function, such as formatting the memory device 104.

The memory controller 106 may communicate with an external device (e.g., host 108) according to a particular communication protocol. For example, the memory controller 106 may communicate with the external device through at least one of various interface protocols, such as a USB protocol, a Multi Media Card protocol, a Peripheral Component Interconnect (PCI) protocol, a Peripheral Component Interconnect Express (PCI-E) protocol, an Advanced Technology Attachment (ATA) protocol, a serial ATA protocol, a parallel ATA protocol, a Small Computer System Interface (SCSI) protocol, an Enhanced Small Drive Interface (ESDI) protocol, an Integrated Drive Electronics (IDE) protocol, a FireWire protocol, and the like.

The memory controller 106 and the one or more memory devices 104 may be integrated into various types of memory, e.g., included in the same package (e.g., Universal Flash Storage (UFS) package or eMMC package). For example, the memory system 102 may be implemented and packaged into different types of terminal electronics.

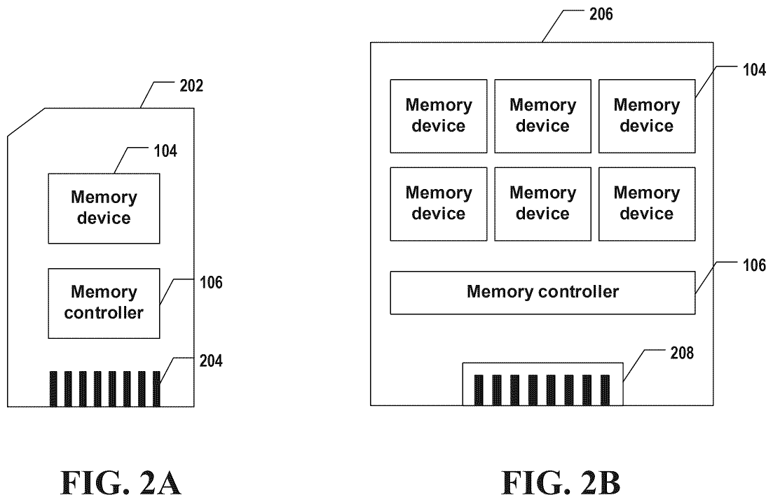

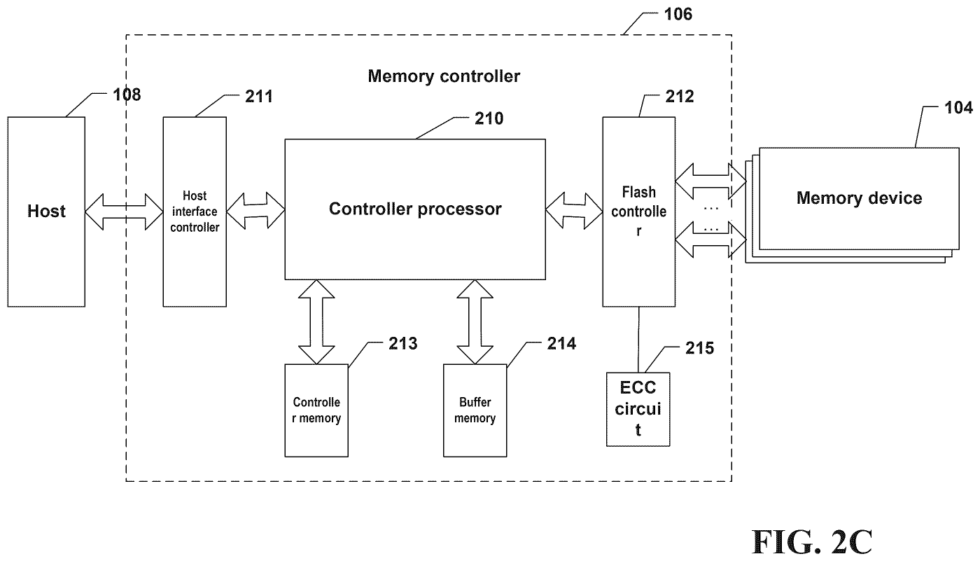

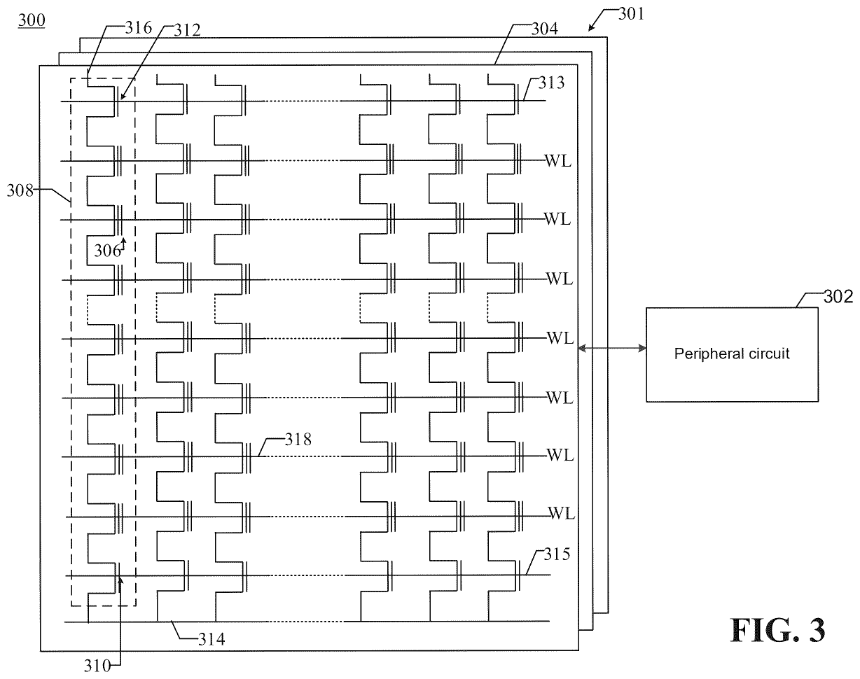

FIG. 2A illustrates a block diagram of a memory system according to an example of the present disclosure. As shown in FIG. 2A, a memory controller 106 and a memory device 104 may be integrated into a memory card 202. The memory card 202 may include a Personal Computer Memory Card International Association card (PC card), a CF card, a smart media (SM) card, a memory stick, a multimedia card (MMC), an SD card, a UFS, or the like. The memory card 202 may also include a memory card connector 204 that couples the memory card with a host (e.g., host 108 in FIG. 1).

FIG. 2B illustrates a block diagram of another memory system according to an example of the present disclosure. As shown in FIG. 2B, a memory controller 106 and a plurality of memory devices 104 may be integrated into a solid-state disk (SSD) 206. SSD 206 may also include an SSD connector 208 that couples SSD 206 with a host (e.g., host 108 in FIG. 1). In some examples, the storage capacity and/or operating speed of SSD 206 is greater than the storage capacity and/or operating speed of the memory card 202.

FIG. 2C illustrates a schematic diagram of an example memory controller of a memory system in an example of the present disclosure. As shown in FIG. 2C, a memory controller 106 is respectively coupled to a host 108 and one or more memory devices 104, and is configured to control sending data to the memory device 104 by the host 108 or reading data from the memory device 104 to return to the host 108. The memory controller 106 includes at least a controller processor 210, a host interface controller 211, a flash controller 212, a controller memory 213, a buffer memory 214, and an error correction code (ECC) circuit 215.

The controller processor 210 may be configured to execute control logic and algorithms of the memory controller, including but not limited to being responsible for functions such as address mapping, garbage collection, wear leveling, and the like. The controller processor 210 may be implemented by an embedded processor or an FPGA.

The host interface controller 211 is respectively coupled to the host 108 and the controller processor 210. The host interface controller 211 may be a communication interface component between the host and the memory controller, and is responsible for data transmission between the host and the memory controller, including reading and writing of data, and receiving and sending of commands. The host interface controller 211 usually supports various interfaces (such as Serial Advanced Technology Attachment (SATA), PCIe) and protocols (such as Advanced Host Controller Interface (AHCI) and Non-Volatile Memory Express (NVMe)), and provides a data transmission function.

The flash controller 212 is respectively coupled to the memory device 104 and the controller processor 210, and may be a communication interface component between the memory device and the memory controller.

The controller memory 213 is coupled to the controller processor 210, and may include a storage area for storing instructions and data. The controller memory 213 may be a storage medium such as NOR flash, NAND flash or RAM.

The buffer memory 214 is coupled to the controller processor 210, and may include a component for temporarily storing data. The buffer memory 214 may also be configured to buffer instructions and data. The buffer memory 214 may be a high-speed storage device such as a Dynamic Random-Access Memory (DRAM) and a Static Random-Access Memory (SRAM).

The ECC circuit 215 is used for error detection and correction of data read from a memory device. The ECC check data may be stored in a reserved space of the memory device 104 for checking of the data.

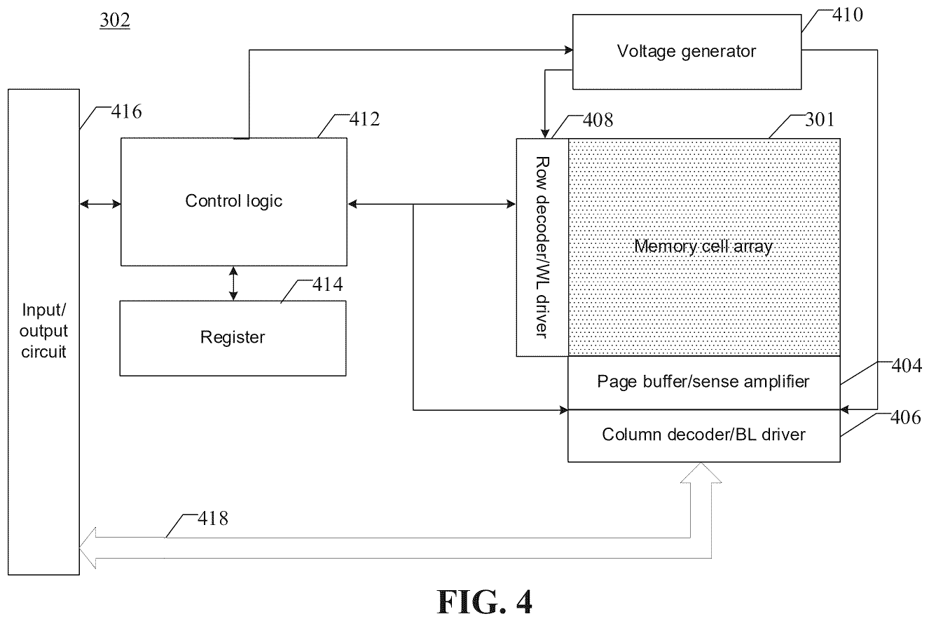

FIG. 3 illustrates a schematic circuit diagram of a memory including a peripheral circuit provided according to an example of the present disclosure. Memory device 300 may be an example of the memory device 104 in FIG. 1. The memory device 300 may include a memory cell array 301 and a peripheral circuit 302 coupled to the memory cell array 301. The memory cell array 301 may be an array of NAND flash memory cells, where memory cells 306 are provided in the form of an array of memory strings 308 of NAND flash, with each memory string 308 extending vertically above a substrate (not shown).

In some examples, the peripheral circuit 302 is configured to perform the operating method provided by the examples of the present disclosure. The peripheral circuit 302 may be configured to execute the operating method provided by the examples of the present disclosure according to the received instruction of the memory controller 106.

In some examples, each memory string 308 includes a plurality of memory cells 306 coupled in series and stacked vertically. Each memory cell 306 may maintain a continuous analog value, e.g., voltage or charge, depending on the number of electrons captured within the area of the memory cell 306. Each memory cell 306 may be a floating gate type memory cell including a floating gate transistor, or a charge trapping type memory cell including a charge trapping transistor.

In some examples, each memory cell 306 may store 1-bit data or 2-bit data or more bits of data, for example, may be a Single-Level Cell (SLC) type, a Multi-Level Cell (MLC) type, a triple-level Cell (TLC) type, a Quad-Level Cell (QLC) type, or a higher-level type. The p (p is a positive integer)-level cell may have 2^{p} states (e.g., one state corresponds to one threshold voltage distribution region), so p-bit data may be stored. The SLC type memory cell may have 2 states, so 1 bit of data may be stored; the MLC type memory cell may have 4 states, so 2 bits of data may be stored; the TLC type memory cell may have 8 states, so 3 bits of data may be stored; the QLC type memory cell may have 16 states, so 4 bits of data may be stored, and so on. In 2^{p} states, one erased state and 2^{p}−1 programmed states may be included. The unit of the p-level cell type NAND flash memory may be in pages, such that program and/or read operation is performed on data page by page. During a program operation, a p-level cell type NAND flash memory cell is programmed to have 2^{p} states, where one memory cell is termed to be in a target program state when being programmed to a target state of 2^{p} states. As shown in FIG. 3, each memory string 308 may include a source select gate (SSG) 310 at its source end and a drain select gate (DSG) 312 at its drain end. The SSG 310 and the DSG 312 may be configured to activate the selected memory string 308 during read and program operations.

In some examples, the sources of the memory strings 308 in the same block 304 are coupled through the same source line (SL) 314 (e.g., a common SL). For example, all memory strings 308 in the same block 304 have an array common source (ACS). As shown in FIG. 3, the memory string 308 may be organized into a plurality of blocks 304, each of which may have a common source line 314 (e.g., coupled to ground). In some examples, each block 304 is a basic unit of data for an erase operation, e.g., all memory cells 306 on the same block 304 are erased at the same time.

In some examples, the transistors of the DSG 312 of each memory string 308 are coupled to a respective bit line (BL) 316, from which data may be read or written via an output bus (not shown). Each memory string 308 may be configured to be selected or deselected by applying a select voltage (e.g., higher than a threshold voltage of a transistor having a DSG 312) or a unselect voltage (e.g., 0V) to a respective DSG 312 via one or more DSG lines 313 and/or by applying a select voltage (e.g., higher than a threshold voltage of a transistor having SSG 310) or a unselect voltage (e.g., 0V) to a respective SSG 310 via one or more SSG lines 315.

As shown in FIG. 3, the memory cells 306 of the memory string 308 may be coupled by a word line (WL) 318, which selects which row of memory cells 306 are affected by read and program operations. The peripheral circuit 302 may be coupled to the memory cell array 301 through the bit line 316, word line 318, source line 314, SSG line 315, and DSG line 313. The peripheral circuit 302 may include any suitable analog, digital, and mixed-signal circuit for facilitating the operation of the memory cell array 301 by applying voltage signals and/or current signals to and sensing voltage signals and/or current signals from each of the memory cells 306 that becomes a target of the operation via the bit line 316, word line 318, source line 314, SSG line 315, and DSG line 313. The peripheral circuit 302 may include various types of peripheral circuits formed using metal-oxide-semiconductor (MOS) technology.

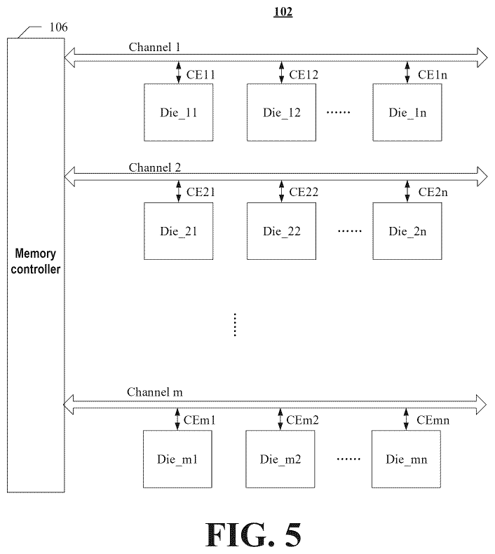

FIG. 4 is a schematic diagram of a peripheral circuit provided according to an example of the present disclosure. As shown in FIG. 4, a peripheral circuit 302 may include a page buffer/sense amplifier 404, a column decoder/BL driver 406, a row decoder/WL driver 408, a voltage generator 410, a control logic 412, a register 414, an input/output (I/O) circuit 416, and a data bus 418. In some examples, additional peripheral circuits not shown in FIG. 4 may also be included.

In some examples, the page buffer/sense amplifier 404 may be configured to read data from and program (write) data to the memory cell array 301 according to control signals from the control logic 412. For example, the page buffer/sense amplifier 404 may store a page of program data (write data) to be programmed into the memory cell array 301. For another example, the page buffer/sense amplifier 404 may also sense a low power signal from the bit line 316 representing a data bit stored in the memory cell 306, and amplify the small voltage swing to an identifiable logic level in a read operation. The column decoder/BL driver 406 may be configured to be controlled by the control logic 412 and select one or more memory strings 308 by applying a bit line voltage generated from the voltage generator 410.

The row decoder/WL driver 408 may be configured to be controlled by the control logic 412 and select/deselect the block 304 of the memory cell array 301 and select/deselect the word line 318 of the block 304. The row decoder/WL driver 408 may also be configured to drive the word line 318 using a word line voltage generated from the voltage generator 410. In some examples, the row decoder/WL driver 408 may also select/deselect and drive the SSG line 315 and DSG line 313. The voltage generator 410 may be configured to be controlled by the control logic 412 and generate word line voltages (e.g., read voltages, program voltages, pass voltages, local voltages, verify voltages, etc.), bit line voltages, and source line voltages, etc. to be supplied to the memory cell array 301.

The control logic 412 may be coupled to each portion of the peripheral circuit 302 and configured to control operation of each portion. The register 414 may be coupled to the control logic 412 and may include status registers, command registers, and address registers for storing status information, command op-codes (OP codes), and command addresses for controlling operation of each peripheral circuit. The input/output circuit 416 may be coupled to the control logic 412 and act as a control buffer to buffer control commands received from the host (not shown in FIG. 4) and relay them to the control logic 412 and buffer status information received from the control logic 412 and relay it to the host. The input/output circuit 416 may also be coupled to the column decoder/bit line driver 406 via the data bus 418 and act as a data I/O interface and a data buffer to buffer data and relay it to the memory cell array 301 or relay or buffer data from the memory cell array 301.

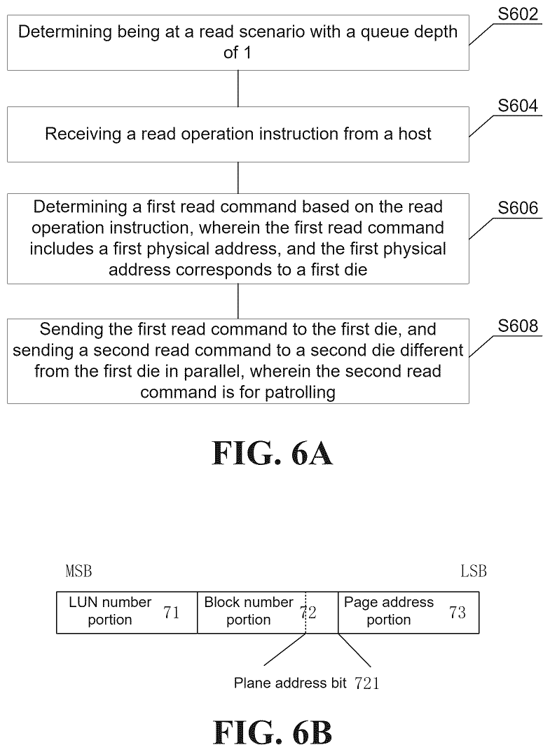

FIG. 5 illustrates a schematic diagram of an architecture of a memory system according to an example of the present disclosure. As shown in FIG. 5, a memory system 102 has one or more memory devices 104 and a memory controller 106. The memory controller 106 is coupled to the one or more memory devices 104 through a plurality of physical channels, Channel 1, Channel 2, Channel m, and sends a control command or transmission data to the memory device 104. The memory device 104 includes one or more dies (also referred to as LUNs). One or more dies, Die_11, . . . , Die_1n, Die_21, . . . , Die_2n, . . . , Die_m1, . . . , Die_mn, are connected on each physical channel. Each die corresponds to a respective chip enable (CE) signal, CE11, . . . , CE1n, CE21, . . . , CE2n, . . . , CEm1, . . . , CEmn. The control command sent by the memory controller 106 to the memory device 104 includes the chip enable signal, and the corresponding die is selected in the physical channel through the chip enable signal, for example, a target die of the control command is selected.

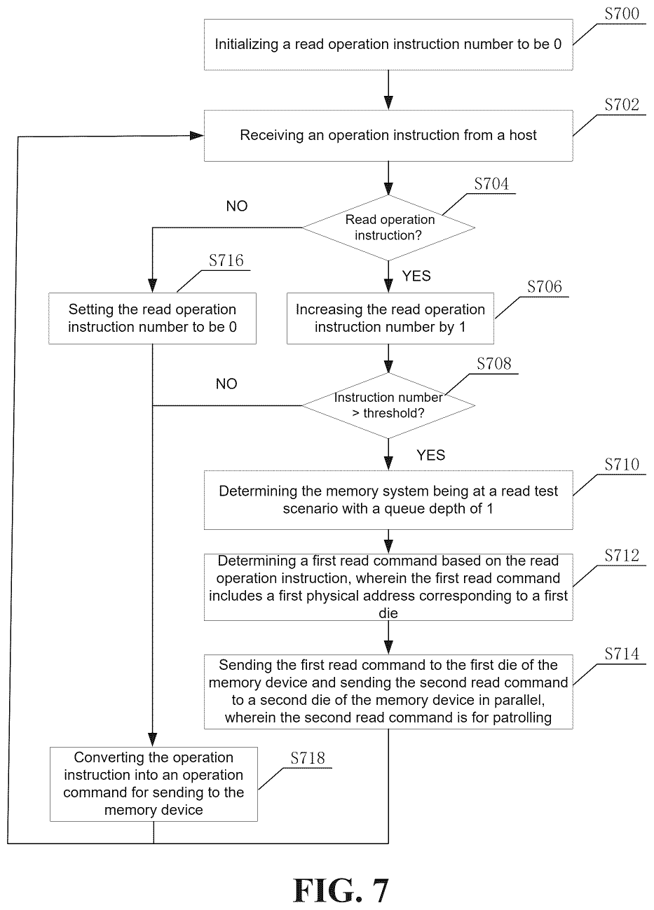

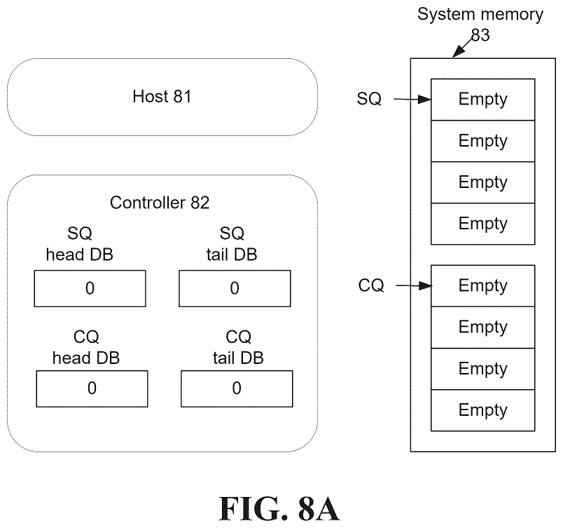

FIG. 6A illustrates a flowchart of a memory system operating method according to an example of the present disclosure. In this example, a memory device includes a plurality of dies.

As shown in FIG. 6A, S602, a memory controller determines being at a read scenario with a queue depth of 1 (QD1). In an example, when a depth of a submission queue of a host is 1, the submission queue includes a read operation instruction, and a quantity of consecutively received read operation instructions exceeds a defined quantity threshold, it is determined that being at a read scenario with a queue depth of 1. The defined quantity threshold may take a value of 6-20.
S604, the memory controller receives a read operation instruction from the host.
S606, the memory controller determines a first read command based on the read operation instruction, where the first read command includes a first physical address, and the first physical address corresponds to a first die. In one example, the first physical address includes a row address and a column address. FIG. 6B illustrates a schematic diagram of a column address according to an example of the present disclosure. As shown in FIG. 6B, a column address in a first read command includes 3 portions: a LUN number portion 71, a block number portion 72, and a page address portion 73. The lowest bit of the block number portion 72 is a plane address bit 721. The memory controller determines the corresponding first die based on the LUN number portion 71 of the column address in the first physical address.
S608, sending the first read command to the first die, and sending a second read command to a second die different from the first die in parallel, where the second read command is for patrolling. Different dies (or LUNs) may receive and execute different commands at the same time; the memory controller sends the first read command to the first die and sends the second read command to the second die at the same time (or within a certain time range). Herein, “in parallel” may refer to that the first read command and the second read command are processed at the same time (or within a certain time range), or may refer to that the first read command and the second read command are processed independently from each other without depending on a processing result of each other. In one example, the second read command is sent to one or more second dies different from the first die. In one example, the second read command is sent to all other dies different from the first die.

In the foregoing example, when determining being at the read scenario with the queue depth of 1, the memory controller sends the first read command to the first die and sends the second read command for patrolling to the second die in parallel, thus avoiding a conflict between processing a host read command and a patrolling read command, reducing the situations that read commands on the same die are blocked due to patrolling, and reducing the impact on the read latency.

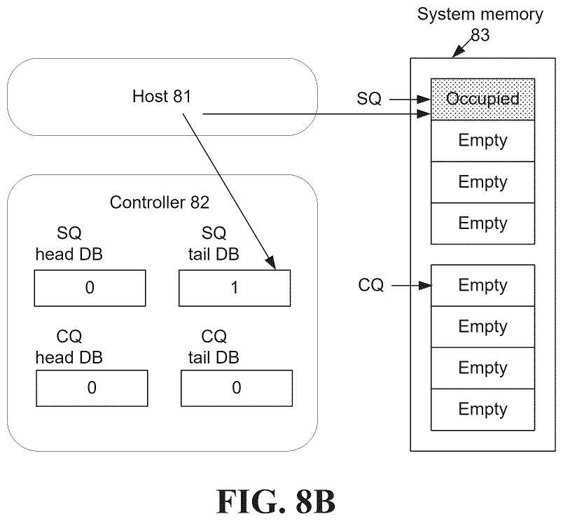

FIG. 7 illustrates a flowchart of a memory system operating method according to another example of the present disclosure. The method is applied to a memory controller of a memory system.

As shown in FIG. 7, S700, initializing a read operation instruction number, for example, setting a read operation instruction number to be 0.
S702, receiving an operation instruction from a host.
S704, determining whether the operation instruction is a read operation instruction? If yes, continue to S706, otherwise, continue to S716.
S706, increasing the read operation instruction number by 1.
S708, determining whether the read operation instruction number is greater than a defined quantity threshold. If yes, continue to S710; otherwise, continue to S718.
S710, determining being at a read scenario with a queue depth of 1.
S712, determining a first read command based on the read operation instruction, where the first read command includes a first physical address, and the first physical address is located in a first die.
S714, generating a second read command, where the second read command is for patrolling; and sending the first read command to the first die of the memory device and sending the second read command to a second die of the memory device in parallel. Continue to S702.
S716, setting the read operation instruction number to be 0.
S718, converting the operation instruction into an operation command for sending to the memory device. Continue to S702.

In the foregoing example, the memory controller receives an operation instruction from the host, determines whether the operation instruction is a read operation instruction. If the operation instruction is a read operation instruction, and a quantity of consecutive read operation instructions is greater than a defined threshold, it is then determined being at a read scenario with a queue depth of 1. Then, the first read command is sent to the first die and a second read command for patrolling is sent to the second die in parallel. This design can accurately determine a read scenario with a queue depth of 1, which is beneficial to the execution of the patrolling read command. If an operation instruction different from the read operation instruction, such as a write operation instruction or an erase operation instruction, is received from the host, it is not in the read scenario of QD1. In this case, the memory controller does not send the second read command for patrolling. When multiple read operation instructions are received in the submission queue of the host, it is not in the read scenario of QD1. In this case, the memory controller does not send the second read command for patrolling.

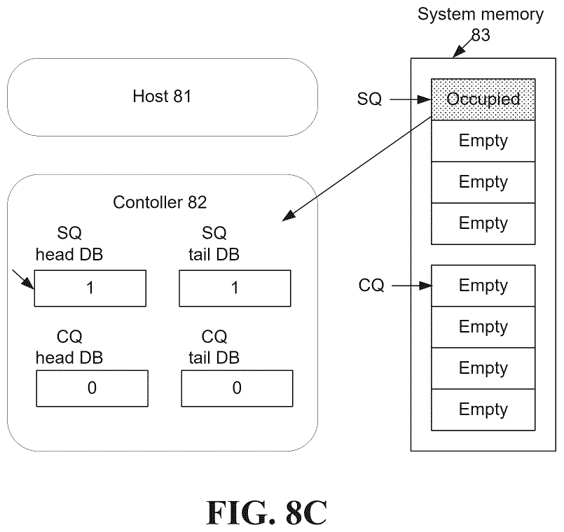

FIGS. 8A-8E illustrate schematic diagrams of a host and a memory controller completing processing of a read operation instruction based on a submission queue (SQ) and a completion queue (CQ) according to an example of the present disclosure. In this example, the submission queue SQ and the completion queue CQ are located in a system memory 83 of a host 81, DB is located in a register of a controller 82, the SQ is configured to store an operation instruction sent by the host, and the CQ is configured to store an instruction completion status. It should be noted that the SQ and the CQ may also be located in the controller 82, and the controller 82 may be an SSD controller. In one example, both SQ and CQ are ring queues, SQ includes the head and tail of the queue, and CQ includes the head and tail of the queue.

As shown in FIG. 8A, both SQ and CQ are in an empty status, SQ head DB and tail DB are both set to initial values 0, and CQ head DB and tail DB are both set to initial values 0. As shown in FIG. 8B, the host 81 writes one read operation instruction in the SQ. At this time, the tail of the SQ becomes 1. The host 81 sets the value of the SQ tail DB to 1, and notifies the controller 82 to fetch the operation instruction from the SQ. As shown in FIG. 8C, the controller 82 obtains the read operation instruction in the SQ for execution. At this time, the header of the SQ is 1, and the controller 82 sets the value of the SQ header DB to 1. As shown in FIG. 8D, executing of the read operation instruction in the SQ is completed. At this time, the SQ is empty. The CQ receives a command completion message returned by the controller 82. At this time, the tail of the CQ is 1. The controller 82 sets the value of the CQ tail DB to 1, and sends a notification message (for example, interrupt information) to the host 81, to notify the host 81 that there is a command completion message. As shown in FIG. 8E, the host 81 obtains the command completion message from the CQ, and sets the value of the CQ header DB to 1. Through the above process, the host 81 and the controller 82 cooperate with each other to complete the processing of the one read operation instruction. The host 81 or the controller 82 may determine the read scenario of QD1 by monitoring the operation instruction in the SQ.

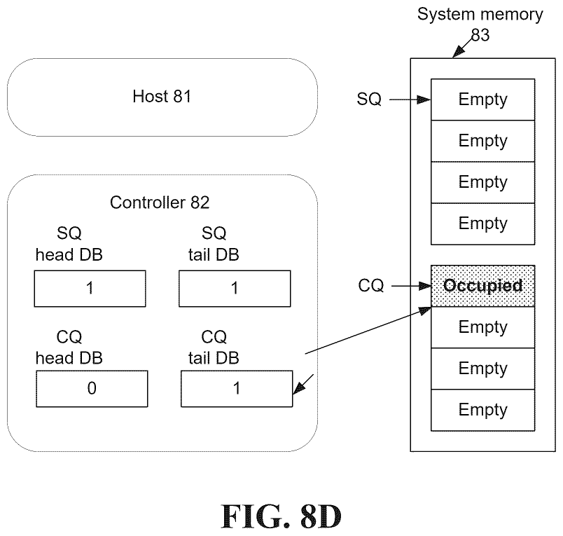

FIG. 9 illustrates a flowchart of a memory system operating method according to still another example of the present disclosure.

As shown in FIG. 9, S902, read operation instructions of QD1 from a host are consecutively received, causing a quantity of read operation instructions exceeds a defined threshold, and thus determining being at a read scenario with a queue depth of 1.
S904: determining a first read command based on a read operation instruction, where the first read command includes a first physical address, and the first physical address corresponds to a first die.
S906: sending the first read command to the first die of the memory device.
S908: sending a second read command to a second die of the memory device in parallel, where the second read command is for patrolling.
S910: receiving a completion result of the first read command from the memory device, and writing the completion result of the first read command to a completion queue of the host.
S912: receiving a completion result of the second read command from the second die of the memory device. In one example, patrolling post processing is performed based on the completion result of the second read command.

In the foregoing example, parallel processing of steps S906 and S908 does not indicate a sequence of execution. The execution of steps S910 and S912 depends on a result of actual execution, and does not indicate a sequence of execution.

In the foregoing example, when determining being at the read scenario with the queue depth of 1, the first read command is sent to the first die, the second read command for patrolling is sent to other dies, and a completion result returned by the first read command and the second read command is received, so that corresponding processing is completed successfully.

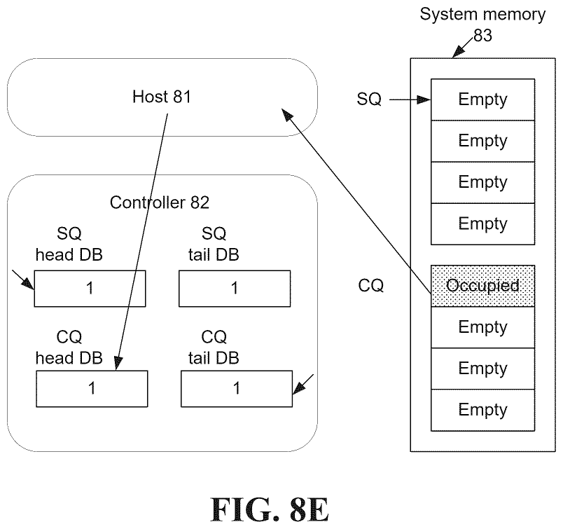

FIG. 10 illustrates a schematic diagram of a memory system according to an example of the present disclosure. As shown in FIG. 10, the memory system includes a host 101, a memory system 102, and a die 1, a die 2, a die 3, . . . , a die N. The memory system 102 includes a patrolling module 1021. The host 101 sends a read instruction to the memory system 102. The memory system 102 sends a first read command to the die 1 of the memory device to read data according to the read instruction. The patrolling module 1021 detects being at a read scenario of QD1, and sends a second read command for patrolling to other dies of the memory device, such as the die 2, the die 3, . . . , the die N, or the like.

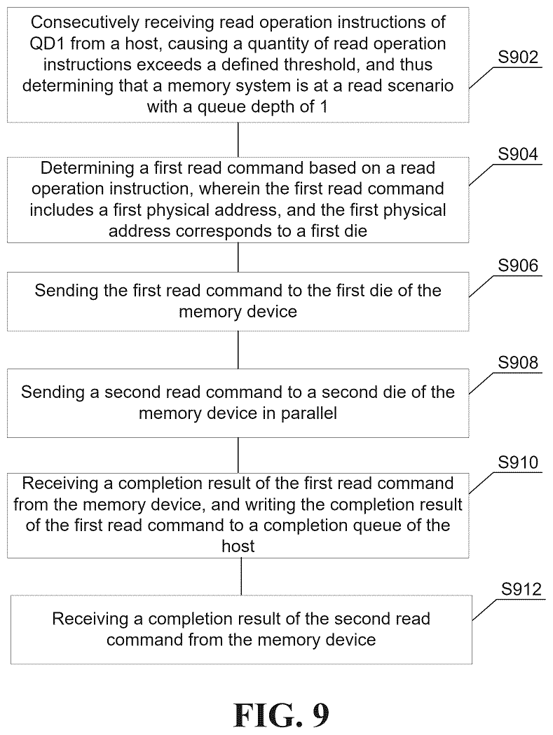

In the above example, the patrolling module 1021 sends the patrolling read command to the dies that are not processing the host read command at the same time, thereby avoiding the situation that the same die is blocked by patrolling, and reducing the influence on the read latency. If the patrolling is performed at a fixed time or a fixed command as an interval, the die may be blocked when entering the patrolling. For example, as shown in FIG. 11, a memory controller 112 sends a read command from a host 111 and a read command for patrolling to the NAND die 1 at the same time, resulting in a conflict. Through the detection and processing of the patrolling module 1021, the situation that the read command from the host 111 conflicts with the read command for patrolling that is sent by the memory controller 112 as shown in FIG. 11 can be avoided. In the above example, through the patrolling module, the patrolling read command is sent to other dies at the same time, thus the conflict caused by patrolling read is better eliminated, and the corresponding QoS latency of QD1 read is reduced.

In one example, the firmware (FW) of the memory controller determines, through the IO mode, that the QD1 read scenario is occurring; uses the patrolling module to send the patrolling read command to other dies that are not performing the host read command at the same time; and after detecting that the IO mode changes, no longer sends the patrolling read command at the same time. In the foregoing manner, the value of the corresponding QoS 99.99% of the QD1 read can be reduced to the same level as the average value.

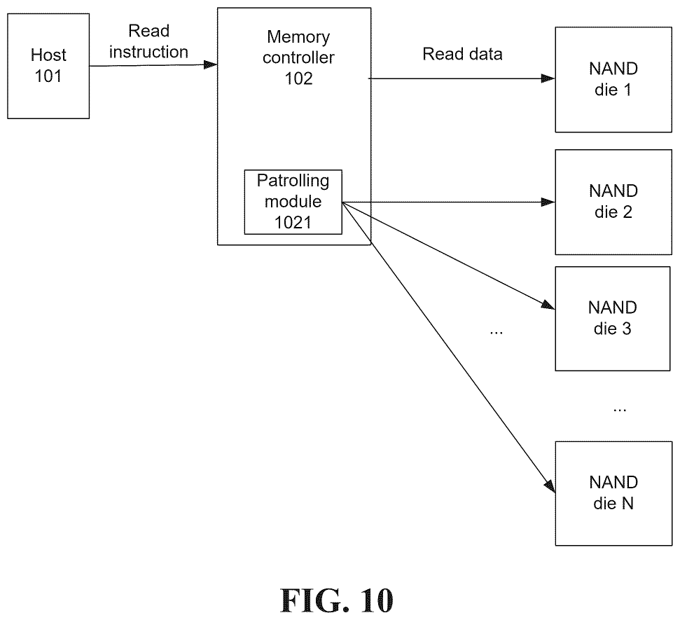

In one example, the second read command is a page read command. FIG. 12 illustrates a sequence diagram of a page read command according to an example of the present disclosure. As shown in FIG. 12, a page read command sequence starts with 00h, where C1-C2 represents the column address of the page, and R1-R3 represents the row address of the page. The row address includes, for example, different portions shown in FIG. 6B, where LUN number portion 71 is used to distinguish between different dies. The page read command represents the end of the page read command with 30h, and then D0, D1, and D2 represent the data returned by read. The second read commands sent to the different dies have different LUN number portions 71. In one example, the second read command indicates to perform a sequential read on the memory cells of the second die.

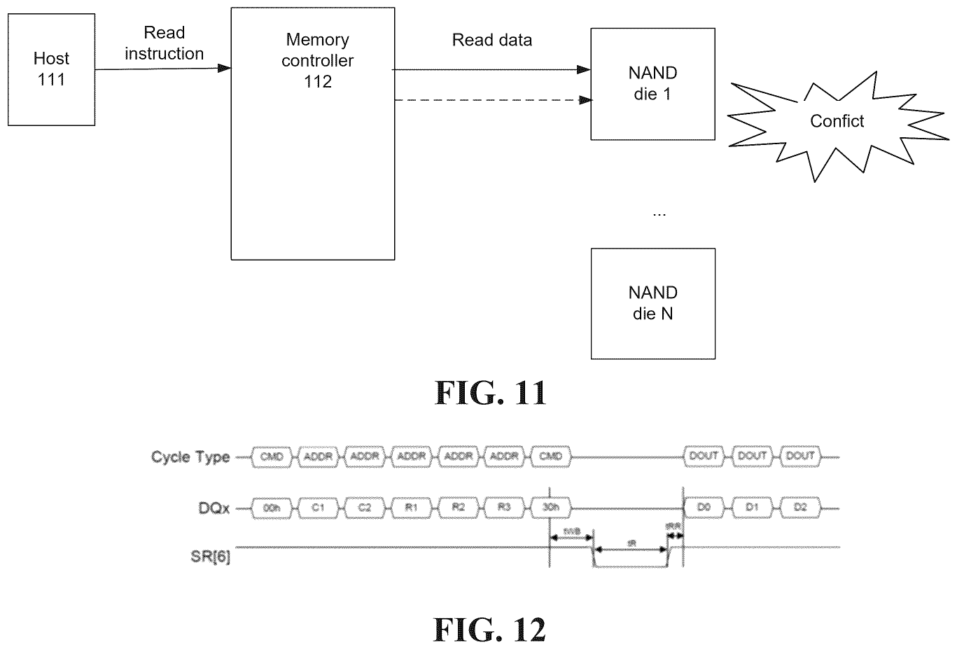

In one example, the second read command is a Multi-plane read command. FIG. 13 illustrates a sequence diagram of a multi-plane read command according to an example of the present disclosure. As shown in FIG. 13, a multi-plane read command sequence starts with 00h, where C1_{A}-C2_{A} represents the column address of page A, R1_{A}-R3_{A} represents the row address of page A; C1_{B}-C2_{B} represents the column address of page B, R1_{B}-R3_{B} represents the row address of page B. The row addresses of page A and page B have different plane address bits. The multi-plane read command represents the end of the multi-plane read command with 30h. The command sequence diagram of FIG. 13 shows only two pages, and those skilled in the art will appreciate that three or more pages may be included.

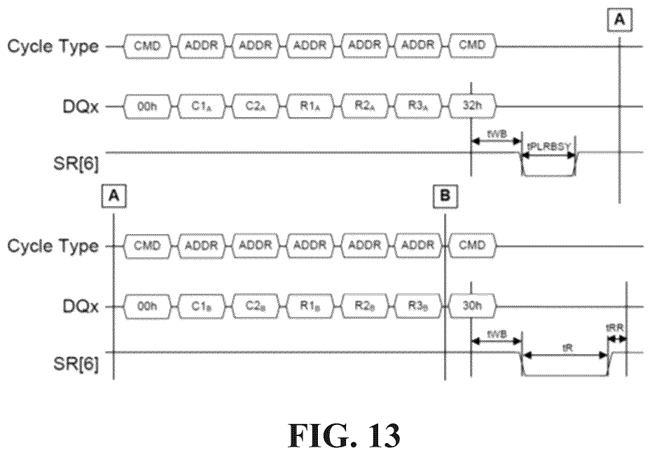

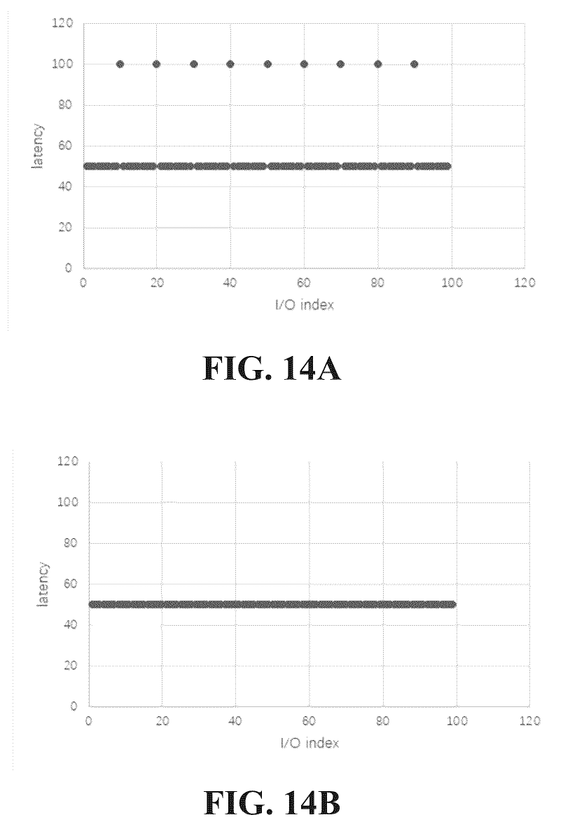

One application scenario of the memory system operating method provided by the present disclosure is to provide a software method of reducing QoS 99.99% in a QD1 host read scenario. The method detects the QD1 read workload through the memory controller (for example, the firmware of the memory controller), starts the patrolling module of the memory controller to avoid the die read by the host read, and sends the patrolling read to other dies at the same time. According to the method, conflict caused by host read and patrolling read can be avoided, and the influence of patrolling read on host read is reduced. In the QD1 read scenario, it is detected by experiments that if the method of the present disclosure is not adopted, high delay results when patrolling occurs as shown in FIG. 14A; and if the method of the present disclosure is adopted, no high delay results after the patrolling conflict is avoided as shown in FIG. 14B.

In an example, the present disclosure also provides a computer-readable storage medium including instructions, for example, a controller memory including instructions, where the instructions may be executed by a controller processor of a memory controller to complete the foregoing methods. Optionally, the computer-readable storage medium may be a ROM, a random-access memory (RAM), a CD-ROM, a magnetic tape, a floppy disk, an optical data storage device, or the like.

In an example, the present disclosure also provides a computer program product, including computer programs/instructions, which when executed by a processor, implement the method in the foregoing examples.

“Some examples” mentioned throughout the specification means that specific features, structures, or characteristics related to the examples are included in at least one example of the present disclosure. Thus, “in some examples” or “in other examples” appearing throughout the specification need not necessarily refer to the same example. Further, these particular features, structures, or characteristics may be incorporated in one or more examples in any suitable manner. In various examples of the present disclosure, the sequence numbers of the foregoing processes do not mean the order of execution, and the execution sequence of each process should be determined by its function and internal logic, and the sequence numbers should not constitute any limitation on the implementation process of the examples of the present disclosure. The sequence numbers of the foregoing examples of the present disclosure are merely for description, and do not represent some examples are more advantages over other examples.

It should be noted that, in this specification, the terms “comprising”, “including”, or any other variant thereof are intended to cover a non-exclusive inclusion, such that a process, method, article, or apparatus that includes a series of elements includes not only those elements but also other elements not explicitly listed, or also includes elements inherent to such process, method, article, or apparatus. Without further restriction, the elements defined by the statement “including one . . . ” do not preclude the presence of additional identical elements in the process, method, article, or apparatus that includes the element.

In several examples provided by the present disclosure, the disclosed apparatus and method may be implemented in other manners. The device examples described above are merely illustrative, for example, the division of the units is merely a logical function division, and in actual implementation, there may be another division manner, for example, multiple units or components may be combined, or may be integrated into another system, or some features may be ignored, or not executed. In addition, the couplings, or direct couplings, or communication connections of the components shown or discussed may be indirect coupling or communication connections through some interfaces, devices, or units, and may be electrical, mechanical, or otherwise.

The units described above as separate components may or may not be physically separate, and components displayed as units may or may not be physical units; they may be located in one place or distributed to multiple network units; some or all of the units may be selected according to actual needs to achieve the purpose of the solutions of the examples.

In addition, various functional units in the examples of the present disclosure may be integrated into one processing unit, or various units may be separately used as a unit, or two or more units may be integrated in one unit; the integrated unit may be implemented in a form of hardware, or may be implemented in a form of a hardware plus software functional units.

The above descriptions are only specific examples of the present disclosure, but the protection scope of the present disclosure is not limited thereto. Any person skilled in the art may easily conceive variations or replacements within the technical scope of the present disclosure, and such variations or replacements should be covered within the protection scope of the present disclosure. Therefore, the protection scope of the present disclosure should be subject to the protection scope of the claims.

What is claimed is:

1. A memory system, comprising:
a plurality of dies; and
a memory controller coupled to the plurality of dies; wherein the memory controller is configured to:
determine being at a read scenario with a queue depth of 1;
receive a read operation instruction from a host;
determine a first read command based on the read operation instruction, wherein the first read command includes a first physical address, and the first physical address corresponds to a first die;
send the first read command to the first die; and
send a second read command to a second die different from the first die in parallel, wherein the second read command is for patrolling.

2. The memory system of claim 1, wherein the memory controller is configured to:
determine being at the read scenario with the queue depth of 1, when a depth of a submission queue of the host is 1, the submission queue includes the read operation instruction, and a quantity of consecutively received read operation instructions exceeds a defined quantity threshold.

3. The memory system of claim 1, wherein the memory controller is further configured to:
prohibit sending the second read command for patrolling, when an operation instruction different from the read operation instruction is received from the host or read operation instructions are received in a submission queue of the host.

4. The memory system of claim 1, wherein the memory controller is configured to:
send the first read command to the first die, and send the second read command to all other dies different from the first die in parallel.

5. The memory system of claim 1, wherein the memory controller is configured to:
send the first read command to the first die, and send the second read command to one or more dies different from the first die in parallel.

6. The memory system of claim 1, wherein the memory controller is further configured to:
obtain the read operation instruction from a submission queue of the host;
receive a completion result of the first read command from a memory device comprising the plurality of dies; and
write the completion result of the first read command to a completion queue of the host.

7. The memory system of claim 1, wherein the second read command indicates to perform a sequential read on memory cells of the second die.

8. A memory controller, comprising:
a controller memory configured to store control instructions; and
a controller processor coupled to the controller memory and configured to execute the control instructions to perform processing comprising:
determining being at a read scenario with a queue depth of 1;
receiving a read operation instruction from a host;
determining a first read command based on the read operation instruction, wherein the first read command includes a first physical address, and the first physical address corresponds to a first die; and
sending the first read command to the first die; and
sending a second read command to a second die different from the first die in parallel, wherein the second read command is for patrolling.

9. The memory controller of claim 8, wherein the processing comprises:
determining being at the read scenario with the queue depth of 1, when a length of a submission queue of the host is 1, the submission queue includes the read operation instruction, and a quantity of consecutively received read operation instructions exceeds a defined quantity threshold.

10. The memory controller of claim 8, wherein the processing further comprises:
prohibiting sending the second read command for patrolling, when an operation instruction different from the read operation instruction is received from the host or read operation instructions are received in a submission queue of the host.

11. The memory controller of claim 8, wherein the processing comprises:
sending the first read command to the first die, and sending the second read command to all other dies different from the first die in parallel.

12. The memory controller of claim 8, wherein the processing comprises:
sending the first read command to the first die, and sending the second read command to one or more dies different from the first die in parallel.

13. The memory controller of claim 8, wherein the processing further comprises:
reading the read operation instruction from a submission queue of the host;
receiving a completion result of the first read command from a memory device comprising the first die and the second die; and
writing the completion result of the first read command to a completion queue of the host.

14. The memory controller of claim 8, wherein the second read command indicates to perform a sequential read on memory cells of the second die.

15. A method of operating a memory controller, comprising:
determining being at a read scenario with a queue depth of 1;
receiving a read operation instruction from a host;
determining a first read command based on the read operation instruction, wherein the first read command includes a first physical address, and the first physical address corresponds to a first die;
sending the first read command to the first die; and
sending a second read command to a second die different from the first die, wherein the second read command is for patrolling.

16. The method of claim 15, wherein determining being at the read scenario with the queue depth of 1 comprises:
determining being at the read scenario with the queue depth of 1, when a length of a submission queue of the host is 1, the submission queue includes the read operation instruction, and a quantity of consecutively received read operation instructions exceeds a defined quantity threshold.

17. The method of claim 15, further comprising:
prohibiting sending the second read command for patrolling, when an operation instruction different from the read operation instruction is received from the host, or read operation instructions are received in a submission queue of the host.

18. The method of claim 15, wherein sending the second read command to the second die different from the first die comprises:
sending the second read command to all other dies different from the first die.

19. The method of claim 15, wherein sending the second read command to the second die different from the first die comprises:
sending the second read command to one or more dies different from the first die.

20. The method of claim 15, further comprising:
reading the read operation instruction from a submission queue of the host;
receiving a completion result of the first read command from a memory device comprising the first die and the second die; and
writing the completion result of the first read command to a completion queue of the host.
